(19) United States
(12) Patent Application Publication
(10) Pub. No.: US 2017/0270558 A1
(43) Pub. Date: Sep. 21, 2017

(54) SYSTEM AND METHOD FOR PROVIDING REAL-TIME NOTIFICATIONS OF LOCATION-BASED REQUIREMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/459,434

(22) Filed: Mar. 15, 2017

Related U.S. Application Data
(60) Provisional application No. 62/308,238, filed on Mar. 15, 2016.

(51) Int. Cl. G06Q 30/02; H04W 4/02; H04L 29/08; G06Q 40/00

(52) U.S. Cl. CPC G06Q 30/0234; G06Q 40/12; H04W 4/02; H04L 67/26; H04L 67/18

(57) ABSTRACT

A system and method for providing real-time notifications of location-based requirements. The method includes retrieving entity data related to an entity associated with a user device; receiving, from the user device, at least one environmental variable, wherein the at least one environmental variable includes a location indicator of a current location of the user device, wherein the at least one environmental variable is received in real-time; determining, based on the received at least one environmental variable, whether at least one requirements notification trigger event has been detected; determining, based on the retrieved entity data, at least one requirement for the current location, when it is determined that at least one requirements notification trigger event has been detected; generating, in real-time, a requirements notification, wherein the requirements notification indicates the determined at least one requirement; and sending the generated requirements notification to the user device.

### CROSS-REFERENCE TO RELATED APPLICATIONS

This application claims the benefit of U.S. Provisional Application No. 62/308,238 filed on Mar. 15, 2016, the contents of which are hereby incorporated by reference.

### TECHNICAL FIELD

The present disclosure relates generally to providing notifications to users, and more particularly to providing notifications indicating location-based requirements.

### BACKGROUND

The Value-Added Tax (VAT) is a broadly based consumption tax assessed on the value added to goods and services. A particular VAT applies to most goods and services that are bought or sold within a given country. When a person travels abroad and makes a purchase that requires paying a VAT, that person may be entitled to a subsequent refund of the VAT for the purchase. Other taxes applied to purchases may similarly be refunded under particular circumstances. Further, sellers may offer rebates for purchases of products sold in certain locations and under particular circumstances. Such refunds of the purchase price may be reclaimed by following procedures established by the refunding entity.

The laws and regulations of many countries allow foreign travelers the right for reimbursement or a refund of certain taxes such as, e.g., VATs paid for goods and services abroad. As such laws and regulations are different from one country to another, determination of the requirements for reclaiming VATs paid in a certain area often requires that the seeker of the refund possess a vast amount of knowledge in the area of tax laws abroad. Moreover, travelers may seek refunds for VATs when they are not entitled to such refunds because they have not complied with all reclaim requirements, thereby spending time and effort on a fruitless endeavor.

Employees making purchases on behalf of businesses while abroad may submit information used for obtaining VAT refunds by the businesses. Every year, a significant amount of VATs are not refunded due to such employees failing to meet the requirements for obtaining a refund. Common reasons for why an employee may not meet VAT reclaim requirements include, for example, the employee not being familiar with VAT reclaim requirements generally or specifically at the location of purchase, and the employee forgetting to ensure that they comply with reclaim requirements (e.g., by obtaining proper documentation, purchasing VAT reclaim eligible items, or by purchasing from an authorized VAT reclaim seller).

Further, even when a buyer remembers to seek a VAT refund, he or she must often look up local VAT reclaim requirements. Looking up VAT reclaim requirements is inconvenient and can be challenging for people who are not familiar with obtaining VAT reclaims. When purchases are time-sensitive (e.g., when the buyer is unwilling or unable to remain at a particular location longer than the time required to make the purchase), buyers are less likely to even attempt to look up and meet VAT reclaim requirements, and may mistakenly look up an incorrect set of requirements (e.g., requirements for reclaiming VAT refunds in another jurisdiction). Moreover, buyers may attempt to look up such requirements after making the purchase only to find out that the purchase was not eligible for VAT refund (e.g., the purchase is for an ineligible item) or that the buyer failed to obtain the necessary documentation (e.g., a receipt showing necessary VAT information). As a result, opportunities for reclaiming VAT refunds are often lost.

It would therefore be advantageous to provide a solution that would overcome the deficiencies of the prior art.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a notification generator according to an embodiment.

FIG. 3 is a flowchart illustrating a method for providing real-time notifications of VAT requirements according to an embodiment.

FIG. 4 is a schematic diagram of an apparatus according to an embodiment.

### SUMMARY

The embodiments disclosed herein include a method for providing real-time notifications of location-based requirements. The method comprises: retrieving entity data related to an entity associated with a user device; receiving, from the user device, at least one environmental variable, wherein the at least one environmental variable includes a location indicator of a current location of the user device, wherein the at least one environmental variable is received in real-time; determining, based on the received at least one environmental variable, whether at least one requirements notification trigger event has been detected; determining, based on the retrieved entity data, at least one requirement for the current location, when it is determined that at least one requirements notification trigger event has been detected; generating, in real-time, a requirements notification, wherein the requirements notification indicates the determined at least one requirement; and sending the generated requirements notification to the user device.

The embodiments disclosed herein also include a non-transitory computer readable medium having stored thereon instructions to be executed by, wherein the instructions, when executed by a processing circuitry, configure the processing circuitry to perform a process for providing real-time notifications of location-based requirements, the process comprising: retrieving entity data related to an entity associated with a user device; receiving, from the user device, at least one environmental variable, wherein the at least one environmental variable includes a location indicator of a current location of the user device, wherein the at least one environmental variable is received in real-time; determining, based on the received at least one environmental variable, whether at least one requirements notification trigger event has been detected; determining, based on the retrieved entity data, at least one requirement for the current location, when it is determined that at least one requirements notification trigger event has been detected; generating, in real-time, a requirements notification, wherein the requirements notification indicates the determined at least one requirement; and sending the generated requirements notification to the user device.

The embodiments disclosed herein also include a system for providing real-time notifications of location-based requirements. The system comprises: a processing circuitry; and a memory, the memory containing instructions that, when executed by the processing circuitry, configure the system to: retrieve entity data related to an entity associated with a user device; receive, from the user device, at least one environmental variable, wherein the at least one environmental variable includes a location indicator of a current location of the user device, wherein the at least one environmental variable is received in real-time; determine, based on the received at least one environmental variable, whether at least one requirements notification trigger event has been detected; determine, based on the retrieved entity data, at least one requirement for the current location, when it is determined that at least one requirements notification trigger event has been detected; generate, in real-time, a requirements notification, wherein the requirements notification indicates the determined at least one requirement; and send the generated requirements notification to the user device.

The embodiments disclosed herein also include an apparatus for providing real-time notifications of location-based requirements. The apparatus comprises: at least one sensor, wherein the at least one sensor includes at least one location-based sensor; a display; a processing circuitry; and a memory, the memory containing instructions that, when executed by the processing circuitry, configure the apparatus to: retrieve entity data related to an entity associated with the apparatus; collect, in real-time via the at least one sensor, at least one environmental variable, wherein the at least one environmental variable includes a location indicator of a current location of the apparatus; determine, based on the collected at least one environmental variable, whether at least one requirements notification trigger event has been detected; determine, based on the retrieved entity data, at least one requirement for the current location, when it is determined that at least one requirements notification trigger event has been detected; generate, in real-time, a requirements notification, wherein the requirements notification indicates the determined at least one requirement; and display, via the display, the generated requirements notification.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

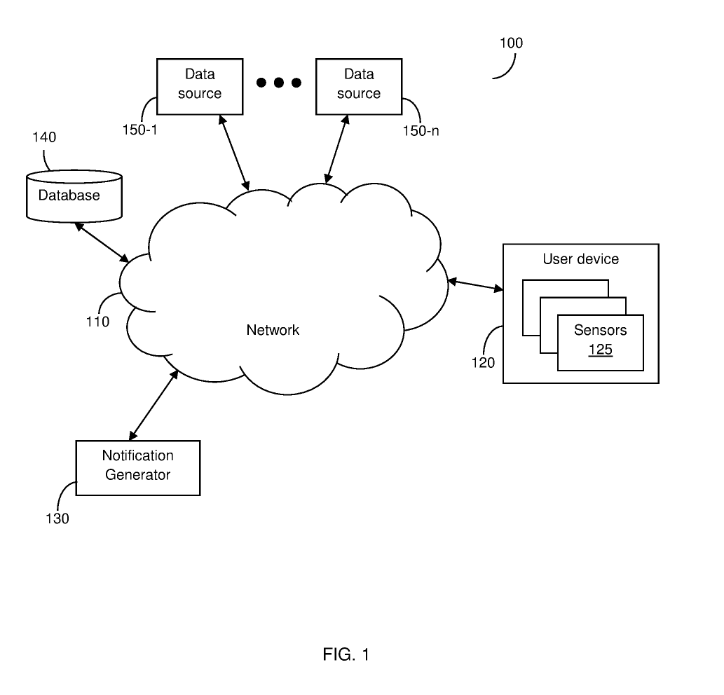

FIG. 1 shows an example network diagram 100 utilized to describe the various disclosed embodiments. In the example network diagram 100, a user device 120, a notification generator 130, a database 140, and a plurality of data sources 150-1 through 150-n (hereinafter referred to individually as a data source 150 and collectively as data sources 150, merely for simplicity purposes) are communicatively connected via a network 110. The network 110 may be, but is not limited to, a local area network (LAN), a wide area network (WAN), a metro area network (MAN), the worldwide web (WWW), the Internet, a wired network, a wireless network, similar networks and any combinations thereof.

The user device 120 may be, but is not limited to, a personal computer (PC), a notebook computer, a cellular phone, a smartphone, a tablet device, a wearable computing device, and so on. The user device 120 may include a plurality of sensors 125, such as but not limited to, global positioning systems (GPSs), network sensors, other sensors that can be utilized to extract a position of the signal, and the like. In an example implementation, the user device 120 is operated by an employee of an enterprise.

The data sources 150 may include, but are not limited to, merchant servers, merchant devices, tax authority servers, accounting servers, and so on. The data sources 150 may store and allow for retrieval of data including but not limited to, VAT reclaim requirements, lists of VAT-authorized merchants, merchant locations, VAT reclaim forms, and the like. The database 140 may be associated with an entity (e.g., an enterprise associated with the user of the user device 120), and may store data related to the associated entity (e.g., company information such as location, financial information, etc.).

In an embodiment, the notification generator 130 is configured to generate and send, in real-time, notifications indicating location-based requirements to the user device 120. In a typical implementation, the notifications may indicate VAT reclaim requirements for obtaining VAT reclaims for purchases made at the current location. The notifications are generated and sent upon detection of one or more notification trigger events. The notification trigger events may be related to, e.g., potential VAT transactions that may be made by the user of the user device 120, and are detected based on contextual parameters related to the user device 120. Generating and sending the notifications in real-time based on trigger events allows for automatically displaying such notifications, e.g., via a display (not shown) of the user device 120 in real-time before or during purchases, or otherwise before the user leaves the location of a purchase.

In an embodiment, the notification generator 130 is configured to retrieve entity data related to an entity associated with the user device 120 such as, but not limited to, country of incorporation, countries of operations, country of residence, whether the entity is a business or a private person, and the like. The data may be retrieved from, e.g., the database 140. The retrieved data may be utilized to determine, e.g., whether a current potential for a requirements notification trigger event, which requirements to be indicated in the notification, and the like. As a non-limiting example, if the current country in which the user device 120 is located is the same as the country of incorporation of a company associated with the user device 120 or as the country of residence of the user of the user device 120, the purchase may not be eligible for VAT refund. As another non-limiting example, if the entity is a private person, the types of items eligible for VAT reclaim indicated by the requirements may be different than if the entity is a business.

In an embodiment, the notification generator 130 is configured to receive, in real- time, at least one environmental variable from the user device 120. The environmental variables indicate current information related to the user device 120 and may include, for example, a location indicator (e.g., an indicator of a geographical location), a time indicator, a combination thereof, and the like. In a further embodiment, the notification generator 130 is configured to receive the at least one environmental variable or a portion thereof periodically at predetermined time intervals or when the at least one environmental variable changes, thereby allowing for real-time detection of notification trigger events based on the environmental variables.

In an embodiment, based on the received at least one environmental variable, the notification generator is configured to retrieve merchant data stored in one or more of the data sources 150. The merchant data is related to at least one merchant at or near (e.g., within a predetermined threshold distance) of the current location of the user device 120 and may include, but is not limited to, merchant registration information (e.g., indicating each merchant that is registered for VAT reclaims), types of goods and services sold by each merchant (e.g., electronics, jewelry, hotel stays, cars, clothing, etc.), a type of each merchant (e.g., hotel, electronics store, jewelry store, car dealership, etc.), a combination thereof, and the like.

In an embodiment, based on a plurality of contextual parameters, the notification generator 130 is configured to determine whether there is a current event potential for a requirements notification trigger event (e.g., whether there is potential for obtaining a VAT reclaim based on a purchase made at the current location). The contextual parameters include the received environmental variables. The contextual parameters may further include, but are not limited to, the retrieved entity data, the retrieved merchant data, both, and the like.

In a further embodiment, the notification generator 130 is configured to determine whether there is a current event potential based on one or more event potential rules. The event potential rules may include, but are not limited to, the merchant at the current location being of a particular type, the merchant at the current location selling at least one VAT-eligible good or service, the merchant at the current location being registered for VAT reclaims, the country of the current location being different from a country of residence or a country of operations of the entity associated with the user device 120, a combination thereof, and the like. As a non-limiting example, upon determination that the user device 120 is currently at a hotel in Copenhagen and that the entity associated with the user device 120 is a company established in Germany, it is determined that a current VAT reclaim potential (and, therefore, a current event potential) exists. As another non-limiting example, upon determining that the user device 120 is currently at a VAT-registered jewelry store in England and that the entity associated with the user device 120 is a private person residing in the United States, it is determined that a current event potential exists.

In an embodiment, upon determining a current event potential, it is checked whether at least one requirements notification trigger event has been detected. In a further embodiment, if a current event potential is not determined, it is not checked whether any requirements notification trigger events have been detected. Only checking for requirements notification trigger events when there is a current event potential may allow for, e.g., reduced use of computing resources when the user of the user device 120 is not currently able to make a reclaim-eligible transaction (e.g., when the user device 120 is in the country of residence of the user or when the user device 120 is not near any merchants such as stores or hotels).

The requirements notification trigger events may be detected based on the contextual parameters and may include, but are not limited to, the user device 120 arriving at the location of a merchant, the user device 120 being at the location of a merchant for a threshold time period (e.g., a predetermined time period), both, and the like. The requirements notification trigger events may further depend on a type of the merchant at the current location of the user device 120. As a non-limiting example, the requirements notification trigger events may include the user device 120 arriving at a location of an electronics store or being at the location of the electronics store for at least 5 minutes, and may further include the user device 120 being at a location of a hotel for at least 6 hours.

In another embodiment, upon determining that there is not a current event potential, the notification generator 130 may be configured to generate and send, in real-time, an ineligibility notification to the user device 120. The ineligibility notification may indicate, e.g., that the user will not be eligible to a VAT reclaim for purchases made at the current location. The real-time ineligibility notification may be utilized to, e.g., prevent or discourage the user of the user device 120 from making purchases that cannot be reclaimed.

In an embodiment, upon detecting at least one requirements notification trigger event, the notification generator 130 is configured to determine at least one requirement for the current location. In a further embodiment, the at least one requirement may be or may include at least one requirement for submitting a VAT reclaim based on a purchase made at the current location. Such requirements may include, but are not limited to, types of goods and services for which VAT reclaims can be obtained, required documentation (e.g., an invoice, a tax receipt, etc.), minimum purchase price, a combination thereof, and the like. The at least one requirement may further include required information, e.g., information that should be included in a VAT reclaim request such as, for example, merchant information (e.g., name or address), purchase information (e.g., transaction number, product name, product description, quantity, expense, etc.), and so on.

In a further embodiment, the notification generator 130 is configured to retrieve the at least one requirement from at least one of the data sources 150. Each data source 150 from which the at least one requirement is retrieved may be, but is not limited to, a server of a tax authority of a current country. In yet a further embodiment, the notification generator 130 is configured to determine the current country based on the location of the user device 120 and to select, based on the determined current country, the at least one data source 150 from which to retrieve requirements.

In another embodiment, if more than one merchant is at or near the current location (e.g., if the user device 120 is at the location of a mall or other shopping center), the at least one requirement may include a set of requirements for obtaining VAT reclaim requirements for each merchant. In a further embodiment, the notification may include each set of requirements.

In an embodiment, the notification generator 130 is configured to generate a requirements notification including the determined at least one requirement. In a further embodiment, the notification generator 130 is configured to send, to the user device 120, the generated requirements notification in real-time. The user device 120 may be configured to display (e.g., via a display of the user device 120, not shown) the notification in real-time. The notification may include, but is not limited to, a checklist indicating each determined requirement.

In an embodiment, the notifications generator 130 may be configured to determine a time for sending the requirements notification. The time may be immediately, at a certain later time, after a predetermined period of time, and the like. In a further embodiment, the time for sending the requirements notification may be determined based on the type of merchant. Sending the notification at a later time may be utilized to, e.g., provide a reminder or otherwise provide the requirements at a time closer to the user of the user device 120 completing a transaction or leaving the current location. As a non-limiting example, for a jewelry store, the determined sending time may be immediately, while for a hotel, the determined sending time may be at 8 AM (e.g., closer to a typical checkout time), thereby providing the requirements in real-time when the user would be able to ensure that all requirements have been met.

It should be understood that the embodiments disclosed herein are not limited to the specific architecture illustrated in FIG. 1, and other architectures may be equally used without departing from the scope of the disclosed embodiments. Specifically, each of the server 120 may resides in a cloud computing platform, a datacenter, and the like. Moreover, in an embodiment, there may be a plurality of servers operating as described hereinabove and configured to either have one as a standby, to share the load between them, or to split the functions between them.

In an optional embodiment, the user device 120 may include a processing circuitry (not shown) and a memory (not shown). The memory contains instructions that, when executed by the processing circuitry, configures the user device 120 to perform the embodiments disclosed herein. In such an embodiment, the user device 120 may generate real-time notifications indicating value-added tax (VAT) reclaim requirements as described further herein instead of the notification generator 130, and may be configured to display the generated notifications on a display of the user device 120.

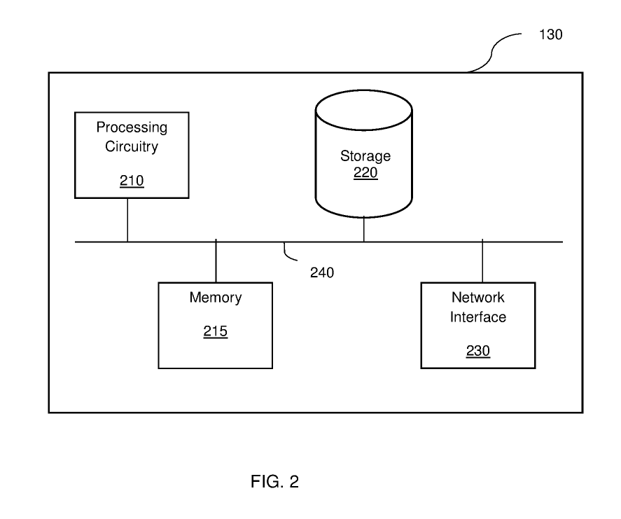

FIG. 2 is an example schematic diagram of the notification generator 130 according to an embodiment. The notification generator 130 includes a processing circuitry 210 coupled to a memory 215, a storage 220, and a network interface 230. In another embodiment, the components of the notification generator 130 may be communicatively connected via a bus 240.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to provide notifications indicating location- based requirements as described herein.

The storage 220 may be magnetic storage, optical storage, and the like, and may be realized, for example, as flash memory or other memory technology, CD-ROM, Digital Versatile Disks (DVDs), or any other medium which can be used to store the desired information. The storage 220 may be configured to store entity data related to entities associated with user devices to be utilized as contextual parameters, requirement notification triggers, and the like.

The network interface 230 allows the notification generator 130 to communicate with the user device 120, the database 140, and the data sources 150, for the purposes of, for example, receiving environmental variables, retrieving merchant data and entity data, retrieving VAT reclaim requirements, and the like.

It should be understood that the embodiments described herein are not limited to the specific architecture illustrated in FIG. 2, and other architectures may be equally used without departing from the scope of the disclosed embodiments.

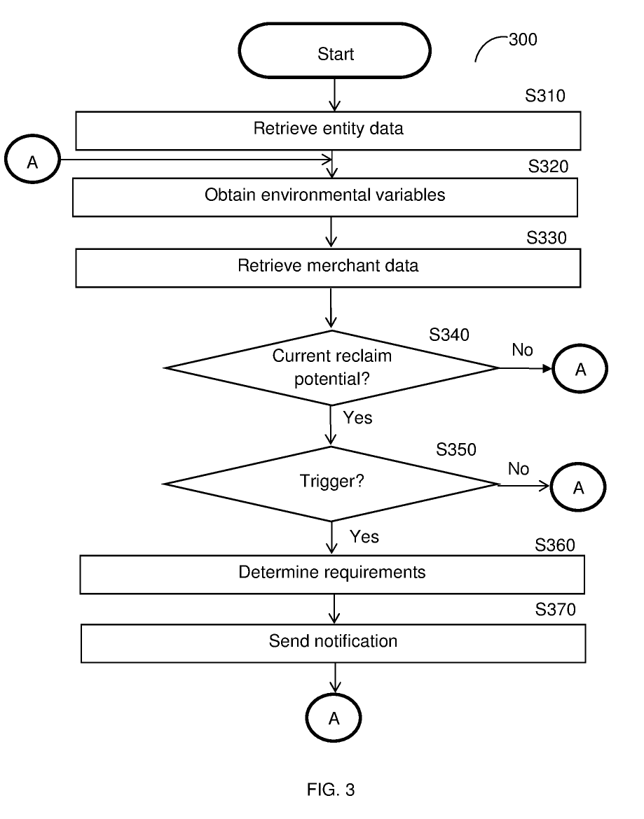

FIG. 3 is an example flowchart 300 illustrating a method for providing real-time notifications of location-based requirements according to an embodiment. In an embodiment, the method may be performed by the notification generator 130. In another embodiment, the location-based requirements may be requirements for obtaining a VAT reclaim for a purchase made at the current location.

At S310, entity data related to an entity associated with a user device is retrieved. The entity data may be retrieved from, for example, a database (e.g., the database 140, FIG. 1), from a local storage (e.g., the storage 220, FIG. 2), and the like. The entity data may include, but is not limited to, country of incorporation, country of operations, country of residence, whether the entity is a company or a private person, and the like. The entity data may be, but is not limited to, metadata or other data of the entity.

At S320, at least one environmental variable is obtained in real-time. The at least one environmental variable may be received from, e.g., the user device. The at least one environmental variable may include, but is not limited to, a location indicator, a time indicator, both, and the like. In an embodiment, the at least one environmental variable at least includes a location indicator of a current location of the user device. The at least one environmental variable, or a portion thereof, may be captured by the user device (e.g., via one or more sensors of the user device).

At S330, merchant data related to a merchant at or near the current location of the user device is retrieved. The merchant may be at or near the current location if the merchant is, e.g., within a threshold distance (for example a predetermined threshold) of the current location. The merchant data may be retrieved from, e.g., at least one data source, based on the received at least one environmental variable. The merchant data may include, but is not limited to, whether there is a merchant at or near the current location, VAT reclaim registration information, types of goods and services sold by the merchant, a type of the merchant, a combination thereof, and the like. In an embodiment, if no merchant is at or near the current location, S330 may result in a null value indicating that there is no known merchant at the current location.

At optional S340, it may be determined whether there is a current event potential for a requirements notification trigger event based on a purchase made given a plurality of current contextual parameters and, if so, execution continues with S350; otherwise, execution continues with S320. The contextual parameters relate to a current context of the user device. The contextual parameters may include the received at least one environmental variable, and may further include the entity data, the merchant data, or both. The determination at S340 may be based on one or more event potential rules such as, but not limited to, a merchant existing at or near the current location, eligible merchant types, eligible goods and services, a merchant registration requirement (e.g., a requirement that a merchant be registered for VAT reclaims), a requirement for a country of the current location and a country of origin of the entity associated with the user device being different, a combination thereof, and the like. In another embodiment, when it is determined that there is not a current event potential, an ineligibility notification may be generated and sent to the user device. The ineligibility notification may indicate, for example, that it is not possible to meet location-based requirements (e.g., requirements for obtaining a VAT reclaim) at the current location.

At S350, when it is determined that there is a current reclaim potential, it is determined whether at least one requirements notification trigger event has been detected and, if so, execution continues with S360; otherwise, execution continues with S320. In an embodiment, the determination at S350 is based on the contextual parameters. The requirements notification trigger events may include, but are not limited to, the user device arriving at the location of a merchant, the user device being at the location of a merchant for a threshold time period (e.g., a predetermined time period with respect to a first time of the user device being at the current location), both, and the like. The requirements notification trigger events may further depend on a type of the merchant at the current location.

At S360, when a requirements notification trigger event has been detected, at least one requirement for the current location is determined. The at least one requirement may be at least one requirement for reclaiming a VAT for a purchase made at the current location and may include, but is not limited to, eligible types of goods and services (e.g., goods and services for which VAT reclaims can be obtained), required documentation (e.g., an invoice, a tax receipt, etc.), minimum purchase price, a combination thereof, and the like. The at least one requirement may further include information that should be included in a VAT reclaim request such as, for example, merchant information (e.g., name or address), purchase information (e.g., transaction number, product name, product description, quantity, expense, etc.), and so on.

In an embodiment, S360 includes selecting at least one data source based on the received at least one environmental variable. The selected at least one data source may include a server of a tax authority in a country of the current location. In a further embodiment, S360 includes retrieving, from the selected data source, the at least one requirement.

At S370, a requirements notification is generated and sent, in real-time, to the user device and execution continues with S320. The generated requirements notification includes the determined at least one requirement. The sent notification may be displayed by the user device in real-time. In an example embodiment, the notification may include a checklist illustrating the at least one requirement.

It should be noted that the method described herein above with respect to FIG. 3 is discussed as being performed by the notification generator 130 merely for simplicity purposes and without limitation on the disclosed embodiments. The method may be equally performed by another system including, but not limited to, a user device (e.g., the user device 120). In such an implementation, the environmental variables do not need to be received.

It should be further noted that the method described herein above with respect to FIG. 3 is discussed in relation to a single merchant at the current location merely for simplicity purposes and without limitation on the disclosed embodiments. Requirements may be provided for multiple merchants, where the requirements may differ by merchant.

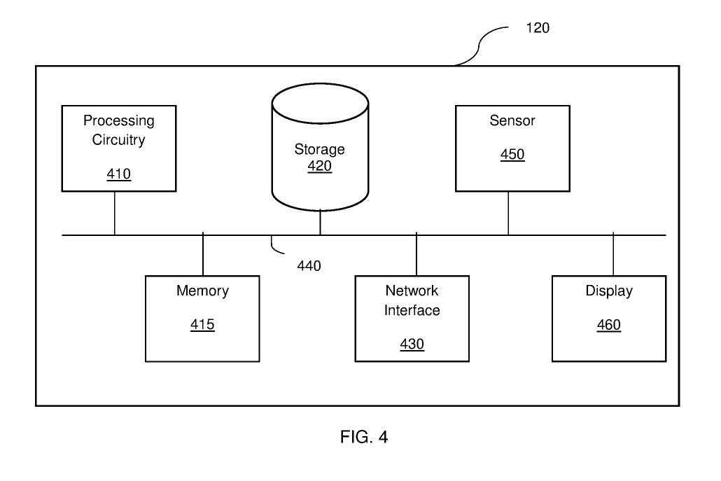

FIG. 4 is an example schematic diagram of the user device 120 according to an embodiment. In an embodiment, the user device 120 is an apparatus configured for generating and displaying, in real-time, notifications of VAT reclaim requirements. The user device 120 includes a processing circuitry 410 coupled to a memory 415, a storage 420, a network interface 430, at least one sensor 450, and a display 460. In another embodiment, the components of the notification generator 130 may be communicatively connected via a bus 440.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 415 may be volatile (e.g., RAM, etc.), non-volatile (e.g., ROM, flash memory, etc.), or a combination thereof. In one configuration, computer readable instructions to implement one or more embodiments disclosed herein may be stored in the storage 420.

In another embodiment, the memory 415 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 410 to perform the various processes described herein. Specifically, the instructions, when executed, cause the processing circuitry 410 to generate and send notifications indicating location-based requirements as described herein.

The storage 420 may be magnetic storage, optical storage, and the like, and may be realized, for example, as flash memory or other memory technology, CD-ROM, Digital Versatile Disks (DVDs), or any other medium which can be used to store the desired information. The storage 420 may be configured to store entity data related to entities associated with user devices to be utilized as contextual parameters, requirement notification triggers, and the like.

The network interface 430 allows the user device 120 to communicate with the database 140 and the data sources 150, for the purposes of, for example, retrieving merchant data and entity data, retrieving VAT reclaim requirements, and the like.

The at least one sensor 450 includes at least one location-based sensor such as, but not limited to, a global positioning system (GPS), a network sensor, or any other sensor that can be utilized to extract a position of the signal.

The display 460 is configured to display, in real-time, requirements notifications generated by the user device 120.

It should be understood that the embodiments described herein are not limited to the specific architecture illustrated in FIG. 4, and other architectures may be equally used without departing from the scope of the disclosed embodiments.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for providing real-time notifications of location-based requirements, comprising:
retrieving entity data related to an entity associated with a user device;
receiving, from the user device, at least one environmental variable, wherein the at least one environmental variable includes a location indicator of a current location of the user device, wherein the at least one environmental variable is received in real-time;
determining, based on the received at least one environmental variable, whether at least one requirements notification trigger event has been detected;
determining, based on the retrieved entity data, at least one requirement for the current location, when it is determined that at least one requirements notification trigger event has been detected;
generating, in real-time, a requirements notification, wherein the requirements notification indicates the determined at least one requirement; and
sending the generated requirements notification to the user device.

2. The method of claim 1, further comprising:
retrieving merchant data related to at least one merchant, wherein the at least one merchant is at least near the current location.

3. The method of claim 2, further comprising:
determining, based on the received at least one environmental variable, whether there is a current potential for a requirements notification trigger event, wherein whether there is a current potential for a requirements notification trigger event is determined based on the received at least one environmental variable and at least one of: the retrieved entity data, and the retrieved merchant data, wherein it is determined whether at least one requirements notification trigger event has been detected when it is determined that there is a current potential for a requirements notification trigger event.

4. The method of claim 3, wherein the retrieved merchant data includes at least one of: a type of each merchant, goods sold by each merchant, services sold by each merchant, and at least one merchant registration.

5. The method of claim 4, wherein whether there is a current potential for a requirements notification trigger event is determined further based on at least one event potential rule, wherein the at least one event potential rule indicates at least one of: at least one eligible type of merchant, at least one eligible good, at least one eligible service, a requirement for a merchant registration, and a requirement for a country of the current location being different from a country of origin of the entity associated with the user device.

6. The method of claim 3, further comprising:
generating an ineligibility notification, when it is determined that there is not a current potential for a requirements notification trigger event; and
send, in real-time, the generated ineligibility notification to the user device.

7. The method of claim 1, wherein the determined at least one requirement includes at least one of: at least one eligible type of good, at least one eligible type of service, required documentation, a minimum purchase price, and required information.

8. The method of claim 7, wherein the required information includes at least one of:
a name of a merchant, an address of a merchant, a transaction number, a product name, a product description, a quantity, and an expense.

9. The method of claim 1, wherein the at least one requirements notification trigger event includes at least one of: the user device arriving at the current location, and the user device being at the current location for at least a predetermined period of time.

10. The method of claim 1, wherein the determined at least one requirement is at least one requirement for obtaining a value-added tax reclaim for a purchase made at the current location.

11. A non-transitory computer readable medium having stored thereon instructions, wherein the instructions, when executed by a processing circuitry, configure the processing circuitry to perform a process for providing real-time notifications of location- based requirements, the process comprising:
retrieving entity data related to an entity associated with a user device;
receiving, from the user device, at least one environmental variable, wherein the at least one environmental variable includes a location indicator of a current location of the user device, wherein the at least one environmental variable is received in real-time;
determining, based on the received at least one environmental variable, whether at least one requirements notification trigger event has been detected;
determining, based on the retrieved entity data, at least one requirement for the current location, when it is determined that at least one requirements notification trigger event has been detected;
generating, in real-time, a requirements notification, wherein the requirements notification indicates the determined at least one requirement; and
sending the generated requirements notification to the user device.

12. A system for providing real-time notifications of location-based requirements, comprising:
a processing circuitry; and
a memory, the memory containing instructions that, when executed by the processing circuitry, configure the system to:
retrieve entity data related to an entity associated with a user device;
receive, from the user device, at least one environmental variable, wherein the at least one environmental variable includes a location indicator of a current location of the user device, wherein the at least one environmental variable is received in real-time;
determine, based on the received at least one environmental variable, whether at least one requirements notification trigger event has been detected;
determine, based on the retrieved entity data, at least one requirement for the current location, when it is determined that at least one requirements notification trigger event has been detected;
generate, in real-time, a requirements notification, wherein the requirements notification indicates the determined at least one requirement; and
send the generated requirements notification to the user device.

13. The system of claim 12, wherein the system is further configured to:
retrieve merchant data related to at least one merchant, wherein the at least one merchant is at least near the current location.

14. The system of claim 13, wherein the system is further configured to:
determine, based on the received at least one environmental variable, whether there is a current potential for a requirements notification trigger event, wherein whether there is a current potential for a requirements notification trigger event is determined based on the received at least one environmental variable and at least one of: the retrieved entity data, and the retrieved merchant data, wherein it is determined whether at least one requirements notification trigger event has been detected when it is determined that there is a current potential for a requirements notification trigger event.

15. The system of claim 14, wherein the retrieved merchant data includes at least one of: a type of each merchant, goods sold by each merchant, services sold by each merchant, and at least one merchant registration.

16. The system of claim 15, wherein whether there is a current potential for a requirements notification trigger event is determined further based on at least one event potential rule, wherein the at least one event potential rule indicates at least one of: at least one eligible type of merchant, at least one eligible good, at least one eligible service, a requirement for merchant registration, and a requirement for a country of the current location being different from a country of origin of the entity associated with the user device.

17. The system of claim 14, wherein the system is further configured to:
generate an ineligibility notification, when it is determined that there is not a current potential for a requirements notification trigger event; and
send, in real-time, the generated ineligibility notification to the user device.

18. The system of claim 12, wherein the determined at least one requirement includes at least one of: at least one eligible type of good, at least one eligible type of service, required documentation, a minimum purchase price, and required information.

19. The system of claim 18, wherein the required information includes at least one of:
a name of a merchant, an address of a merchant, a transaction number, a product name, a product description, a quantity, and an expense.

20. The system of claim 12, wherein the at least one requirements notification trigger event includes at least one of: the user device arriving at the current location, and the user device being at the current location for at least a predetermined period of time.

21. The system of claim 12, wherein the determined at least one requirement is at least one requirement for obtaining a value-added tax reclaim for a purchase made at the current location.

22. An apparatus for providing real-time notifications of location-based requirements, comprising:
at least one sensor, wherein the at least one sensor includes at least one location-based sensor;
a display;
a processing circuitry; and
a memory, the memory containing instructions that, when executed by the processing circuitry, configure the apparatus to:
retrieve entity data related to an entity associated with the apparatus;
collect, in real-time via the at least one sensor, at least one environmental variable, wherein the at least one environmental variable includes a location indicator of a current location of the apparatus;
determine, based on the collected at least one environmental variable, whether at least one requirements notification trigger event has been detected;
determine, based on the retrieved entity data, at least one requirement for the current location, when it is determined that at least one requirements notification trigger event has been detected;
generate, in real-time, a requirements notification, wherein the requirements notification indicates the determined at least one requirement; and
display, via the display, the generated requirements notification.
